(19) United States
(12) Patent Application Publication
(10) Pub. No.: US 2016/0221380 A1
(43) Pub. Date: Aug. 4, 2016

(54) Multiple-Layered Inlay Stencils

(71) Applicant: Larry Tarter, Martinsville, IN (US)

(72) Inventor: Larry Tarter, Martinsville, IN (US)

(21) Appl. No.: 15/008,712

(22) Filed: Jan. 28, 2016

Related U.S. Application Data
(60) Provisional application No. 62/111,790, filed on Feb. 4, 2015.

(51) Int. Cl. B41N 1/24; B44C 1/22

(52) U.S. Cl. CPC B41N 1/24; B44C 1/22

(57) ABSTRACT

A multiple-layered stencil, kit, method and product for creating inlays of any desired shape or design on a base object. Each layer of a multiple-layered stencil has a template region that represents a portion of the design. The layers of the stencil are applied sequentially to cut inlay pieces and corresponding pockets in the base object to receive the inlay pieces.

### CROSS REFERENCE TO RELATED APPLICATIONS

This application claims priority to U.S. Provisional Application No. 62/111,790, filed Feb. 4, 2015 the entire contents of which is herein incorporated by reference.

### FIELD OF THE INVENTION

The present invention relates to a multiple-layered stencil device and method for creating stenciled designs and inlays.

### BACKGROUND OF THE INVENTION

The art of stenciling can be traced back to prehistoric times. Stencils are used to create and apply designs to surfaces in a variety of fields including creative arts, design, and industry. One particular application relates to inlays. Inlays are produced by carving out a shape from a base material and the filling the carved-out space with a corresponding inlay shape that precisely fits into the base material. Inlays are desirable for both aesthetic and utilitarian purposes as a means to add elegance and style to works of art and other crafts. Inlays can also be used to provide actual or perceived elevation of shapes from the surface of a base object.

In woodworking, a craftsman can carve a shaped-recess in a piece of wood, and then carve a corresponding shape from the same or another type of wood, or other material, for placement into the recess to create an inlay. Creating inlays can be labor-intensive, and require great skill and dexterity in carving shapes that are suitable for the creation of elegant inlays.

In practice stencils are sometimes used to create artist designs and inlays. Stencils serve as a template to cut a desired shape. An advantage of using a stencil is that the artisan need only draw or cut around the boundaries of the stencil to create the corresponding shape. Stencils have the further advantage of providing the means to faithfully repeat the process many times.

While stencils can be very useful, especially in graphic design work, there are a number of problems when applied to inlays having a complex shape such as those with regions that are noncontiguous with the template boundaries. Designs which have sharp angular sections and/or holes are difficult, if not impossible, to reproduce accurately using single-layer stencils. In addition, designs having subregions that are noncontiguous with the outer border of the design are also difficult to produce with single layer stencils. These problems can be especially challenging when applied to inlays. Complex inlays cannot be produced using a single-layer stencil without modifying the design to a simpler abstraction which often falls short of the desired result. For example, several letters in the English alphabet have regions that cannot be fully and accurately represented by a single-layer stencil template, such as the letters “A”, “B”, and “D”. In such cases, regions of the shape are located internally to the external boundary and cannot be accurately represented by the stencil. The letters “A”, “B” and “D” contain an internal hole or space that is not part of the outer contiguous boundary of the shape. The letter “A” has an open space above the horizontal arm; the “B” has two open spaces; and the “D” has an open region in the center. This problem has previously been addressed by abstracting such shapes to include bridges in the stencil that link the base platform of the stencil to an internal space. As a consequence, bridges result in a modification of the desired shape.

There remains a need for an improved stench device and method for producing accurate designs and shapes including inlays that can fully and accurately represent and accommodate any shape including complex shapes with sharp angles and holes.

### SUMMARY OF THE INVENTION

The present invention provides a multi-layered stencil device and method for applying designs and shapes onto any surface including but not limited to creating inlays on base objects such as wood, paper, canvas, textiles, fabric, furniture, signs and pieces of art. Inlays can be cut from any suitable material including, but not limited to, wood, plastic, metal, leather, and glass. A device and method of the invention is useful for general stenciling applications in the graphic arts and for creating inlays of any shape, design, and/or pattern including complex shapes having artistic and/or informational content such as letters, numbers, punctuation marks, words, images, patterns, phrases, sentences, flags, logos, marks, scenes, landscapes, geometric shapes, etc.

The multi-layered stencil (MLIS) device and method of the present invention solves these problems by providing a reliable and accurate means for applying designs of any desired shape or configuration onto a base object including but not limited to inlays having complex shapes and/or multiple areas of color and/or other variance of texture and/or material.

Accordingly, it is an object of the present invention to provide a convenient, accurate, and easy-to-use multi-layered stencil device and method for reproducing a design any shape onto any surface or object.

It is another object to provide a multi-layered stencil device for cutting and setting inlays in a base object.

It is another object of the present invention to provide a method using an MLIS stencil for reproducing any design or shape onto any surface or object and a product produced thereby.

It is yet another object to provide kit having a plurality of MLIS layers for reproducing any design or shape.

These and other objects and advantages of the present invention will be apparent from the following description, the accompanying drawings, and the appended claims.

### BRIEF DESCRIPTION OF THE DRAWINGS

FIG. 1 shows an example of a prior art single-layer stencil for creating facsimile of the letter “D”.

FIG. 2A provides as top perspective view of a first layer of a multi-layered stencil device of the invention for producing the letter “D”.

FIG. 2B provides a top perspective view of a second layer of a multi-layered stencil device of the invention for producing the letter “D”.

FIG. 2C provides a top perspective view of the template regions of the layers shown in FIGS. 2A and 2B in stacked arrangement.

FIG. 2D shows a top schematic view of an inlay created by the layers of FIGS. 2A and 2B depicting the letter “D”.

FIG. 3A shows a top perspective view of a first layer of a MLIS stencil of the invention for the letter “A”.

FIG. 3B shows a top perspective view of a second layer of a MLIS stencil of the invention for the letter “A”.

FIG. 3C shows a top perspective view of a third layer of MLIS stencil of the invention for the letter “A”.

FIG. 3D shows a top view schematic of an inlay cut from the layers of FIGS. 3A-3C and aligned to depict the letter “A”.

FIG. 4A is a schematic representation showing application of a first layer MLIS onto the surface of a material from which a first inlay portion is cut for the letter “D”.

FIG. 4B shows a second layer of an MLIS applied to a material to cut a second inlay portion for the letter “D”.

FIG. 5A shows a top view of a workpiece in which a pocket corresponding to the layer of FIG. 4A has been cut and the inlay piece of FIG. 4A placed into the pocket.

FIG. 5B shows a top view of the workpiece of FIG. 5A after creation of a second pocket corresponding to the layer of FIG. 4B and placement of the inlay piece of FIG. 4B into the second pocket.

FIG. 6A provides a top view of a first layer of a MLIS for a solar eclipse inlay.

FIG. 6B provides a top view of a second layer of a MLIS for a solar eclipse inlay.

FIG. 6C provides a top view of a third layer of a MLIS for a solar eclipse inlay.

FIG. 6D provides a top view of a fourth layer of a MLIS for a solar eclipse inlay.

FIG. 6E provides a top view of a fifth layer of a MLIS for a solar eclipse inlay.

FIG. 6F provides a top view of a sixth layer of a MLIS for a solar eclipse inlay.

FIG. 7 provides a top view of a wood inlay project depicting an eclipse produced by applying the MLIS layers of FIGS. 6A-6F.

### DETAILED DESCRIPTION OF PREFERRED EMBODIMENTS

As used herein, the term “inlay” refers to any shape or portion thereof that is cut from any material for placement into a corresponding pocket on the surface of a base object. Inlays can be prepared from any suitable material including, but not limited to, wood, metal, glass, leather, plastic, stone, mother of pearl, shell, horn, bone, ivory, etc.

The term “base object” refers to any object, project, or workpiece for which it is desired to place a design such as an inlay onto a surface for decorative or other purposes. “Base objects” include but are not limited to any type of furniture, plaques, boards, vases, vessels, signs, address signs, cutlery, handles, mats, or any other object on which a design or inlay of the invention is placed or desired to be placed. Base objects can be made from any material including, but not limited to, paper, wood, metal, glass leather, plastic, ceramic, stone, mother of pearl, shell, horn, bone, ivory, etc.

As used herein, the term “bridge” refers to a region of a single layer stencil template that provides a physical connection or support for an internal region such as a hole in a design or shape.

As used herein, the term “ghost line(s)” refers to a mark on the surface of the layers of a multi-layered stencil device which depict a portion or all of the regions of the design that are not represented by the template region.

As used herein, the term “internal” or “internal region” generally refers to a part of a design or shape that is internal to the exterior boundary of the design. For example, the letter “A” has a triangular hole above the horizontal arm, and the letter “D” has a hole that is internal to the outer contiguous boundary of the letter. By contrast, the letters “C” and “E” do not have an internal region as herein defined. An internal region can be other than a hole and can embrace any relevant feature or information of the design such as differences of color, texture, material, etc.

As used herein, the term “stencil” generally refers to a template formed by removing a portion of the stencil base or platform to create an open space(s) that act as a template to replicate the shape or design reflected by the cutaway portion. Single layer stencils generally possess bridges when there is a need to accommodate holes that are inside the outer contiguous boundary of the design or shape.

As used herein, the terms “multi-layered stencil” or “multi-layered inlay stencil”, or “multiple layer inlay stencil”, or “MLIS” refer to a stencil device of the invention having at least two layers that are applied sequentially to reproduce designs or shapes. Taken together, the individual layers of the MLIS capture the entire shape or design with template regions of each layer representing a part of the overall design, and the template regions of at least 2 layers partially overlapping.

As used herein, the term “simple shape” or “simple design” generally refers to a shape or design that lacks sharp, angular corners and/or lacks regions that are internal to the exterior boundary of the design. “Complex shape” or “complex design” refers to a shape or design having at least one sharp or angular corner and/or at least one region that is internal to the exterior boundary of the design.

As used herein, the term “region” or “region of a shape/design” refers to a portion of an MLIS layer or design that represents less than the whole or complete design.

As used herein, the term “sequential” or “sequential use” refers to an aspect of the process by which an MLIS of the invention is applied in use, specifically that MLIS layers are applied in succession to cut an inlay and a corresponding pocket on the surface of a base object to receive the inlay. Thus, for a two-layer MLIS, one of the two layers would be applied first to cut a portion of the inlay from a material and to cut a corresponding pocket in the surface of a base object that receives the inlay. Thereafter, the other layer would be applied to cut a second portion of the inlay and corresponding pocket.

As used herein, the term “pocket” refers to a region cut from the surface of a base object or project the size, shape, and depth of which is designed to receive a corresponding inlay or inlay piece.

As used herein the term “positioning plate(s)” refer to a plate that is used for squaring MLIS stencils and holding them in place when in use to cut an inlay or pocket positioning plates are also used to provide a level surface for cutting with a router to prevent fall-off damage. Positioning plates are preferably fabricated from transparent plastic, are rectangular shaped, having a height of 4 to 10 inches, preferably 4.5 to 7 inches; a width of 4 to 15 inches, preferably 4 to 11.5 inches; and a thickness of 0.1 to inch, preferably 0.22 inches.

As used herein term “base platform” is used in reference to MLIS layers to designate the foundation or base material of each layer out of which template regions corresponding to a portion of a design are cut. The base platform of an MLIS can have any shape but preferably is rectangular-shaped.

As used herein the term “template region” refers to a region or portion of a base platform of an MLIS layer that has been cut away to provide a template for a portion of a design.

A multiple layer inlay stencil device of the present invention provides a simple and accurate way to reproduce any desired shape on a base object, including complex-shapes with sharp corners and/or angles. Complex shapes may be difficult or impossible to accurately represent using single-layer stencils because internal regions or sub-regions of the shape cannot be accurately represented.

The following description relates to inlay applications, but it should be understood that the scope of the invention is not limited to inlays, and any shape can be reproduced for any other application by a device, kit, and method of the present invention.

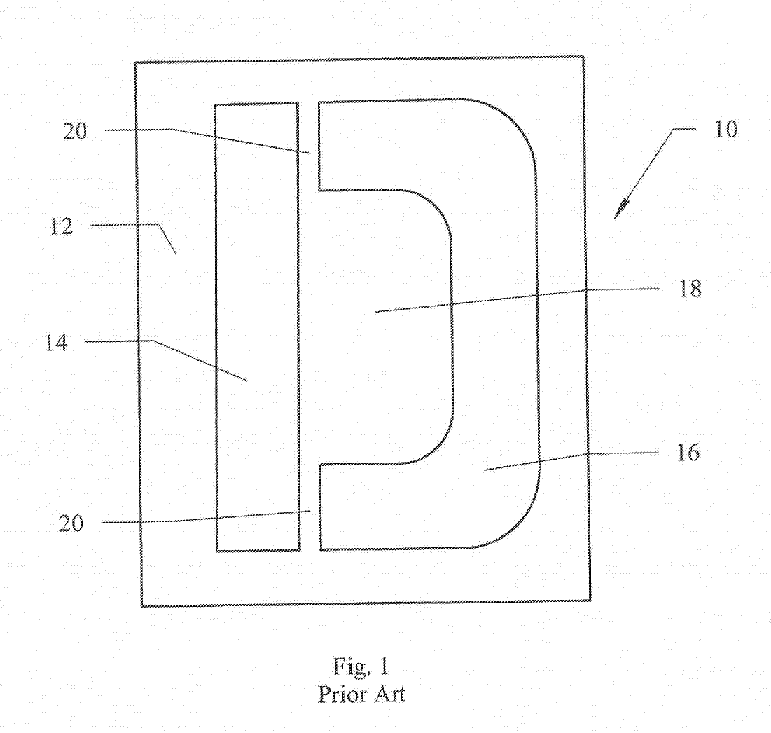

Referring now to the drawings, preferred embodiments of the invention will now be described in more detail. FIG. 1 shows a prior art single-layer stencil for the letter “D”. The stencil 10 includes a base platform 12 out of which is cut a template region for the vertical arm 14 of the “D”, and a template region for the curved section 16 of the “D”. The centrally located hole 18 can be represented by including two bridges 20 which connect the otherwise dangling hole 18 to the base platform 12. The use of bridges 20 results in an abstraction of the letter “D” in the sense that gaps must be introduced between the vertical arm 14 and curved section 16 of the “D”.

A multiple-layered inlay stencil of the present invention includes at least two layers that are applied sequentially to cut inlay pieces and corresponding pockets in a base object. An MLIS of the invention may include any number of layers greater than 1, for example, from 2 to 10 or more layers; alternatively from 2 to 9 layers; alternatively from 2 to 8 layers; alternatively from 2 to 7 layers; alternatively from 2 to 6 layers; alternatively from 2 to 5 layers; alternatively from 2 to 4 layers; alternatively from 2 to 3 layers. Each layer captures a portion of a desired complete shape or design. Depending on the particular shape, sub-regions are selected to be represented by a corresponding number of layers which, when taken together, reconstruct the entire design or shape. Each layer of an MLIS of the invention includes a base platform out of which a template region is removed to represent a portion of the design.

The base platforms of a set of MLIS layers are preferably uniformly sized and rectangular-shaped to facilitate squaring during use. Each layer has a width from 1 to 30 inches, including all unitary and fractional portion within this range, from 0.01 to 0.9 (e.g. 1, 2, 3, . . . 29, 30), and 2.1, 2.2, 2.3 . . . 2.9 inch, etc.). Preferably the width is from 4 to 21 inches. Each layer has a height of 1 to 30 inches, including all unitary and fractional portions within this range, from 0.1 to 0.9 (e.g. 1, 2, 3, . . . 29, 30), and (2.1, 2.2, 2.3 . . . 2.9 inch, etc.); preferably the height is from 4 to 21 inches. Each layer has a thickness of 0.1 to 0.5 inches including 0.1, 0.2, 0.3, 0.4, and 0.5 inches, including all fractional portions thereof, for example, 0.11, 0.12, 0.13 . . . 0.48, 0.49, 0.5 inches; preferably the thickness is 0.22 inches.

The base platform can be fabricated from any suitable material including, but not limited to, plastic, wood, metal, paper, etc. For some applications, including woodworking, transparency of the stencil material is desirable, and for such applications the material is preferably transparent plastic such as acrylic.

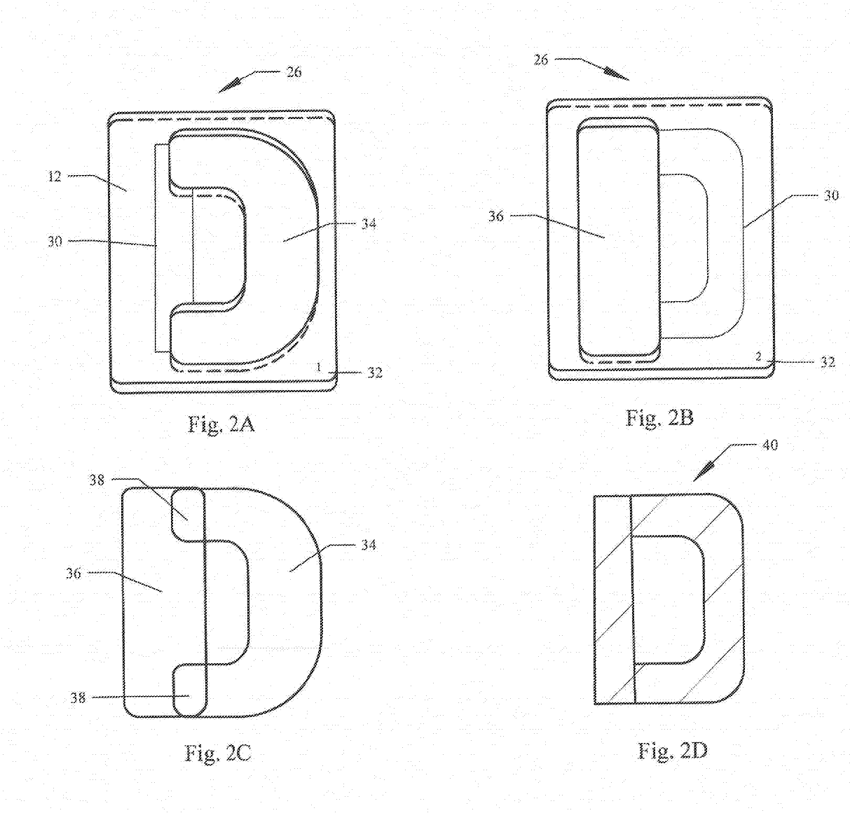

FIG. 2 illustrates an embodiment of a MLIS device 26 of the present invention representing the letter “D”. FIG. 2A depicts a first layer of the MLIS in which a template portion 34 has been removed from the base platform 12 to capture the curved section of the “D”. FIG. 2B depicts a second layer of the MLIS in which a template portion 36 has been cut from the base platform to represent the vertical arm of the letter “D”. FIG. 2C shows that the template portions 34 and 36 have an overlap 38 when the layers are stacked (base platform not shown). FIG. 2D schematically represents an inlay for the letter “D” produced by the layers of FIGS. 2A and 2B.

As shown in FIGS. 2A and 2B, ghost lines 30 are placed on the surface of each layer to represent regions of the design that are not captured by the template region(s) of each layer. Ghost lines facilitate line up of layers during use and are useful in viewing the overall shape of the design when the component layers are aligned and stacked vertically. Ghost lines can be applied to the surface of a layer by any method known to the skilled artisan including, for example, ink, etching, or engraving.

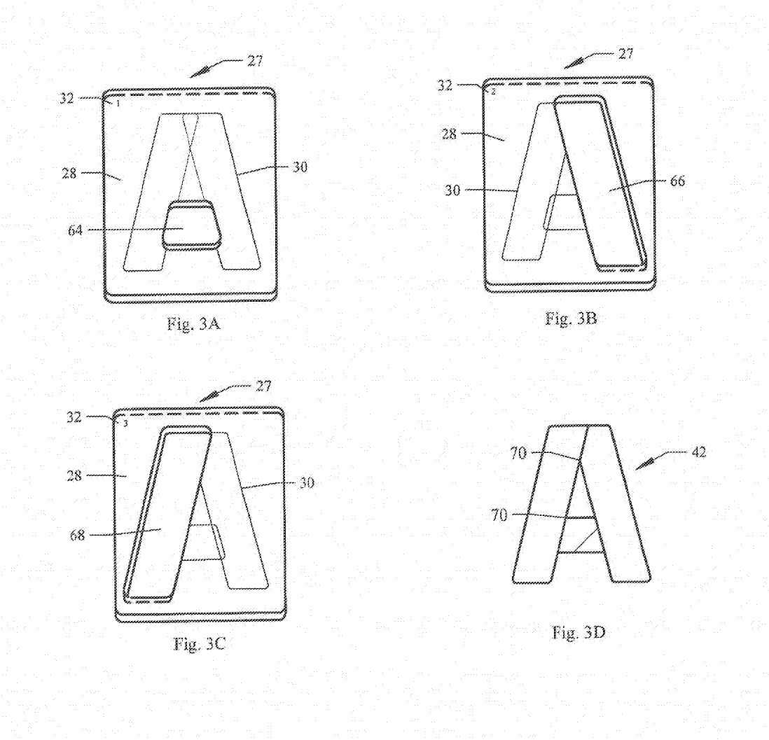

FIG. 3 shows an embodiment of an MLIS 27 for the letter “A”. FIG. 3A represents a first layer in which the horizontal arm member is represented by template region 64. FIG. 3B represents a second layer in which the right arm of the “A” is captured by template region 66. FIG. 3C represents a third layer in which the left arm is captured by template region 68. Again, the surface 28 of each layer includes ghost marks 30 for portions of the design that are outside the template regions, and a mark 32 indicating the order in which each layer is to be applied. FIG. 3D illustrates an inlayed “A” produced by the MLIS layers of FIGS. 3A-3C showing that sharp corners 70 in the letter “A” are accurately represented.

The MLIS layers of the invention can be manufactured by any suitable method known to the skilled artisan. Preferably the layers are produced by computer-aided manufacturing (CAM) technologies and CAD software for precision of design and production.

The dimensions of the template region of each MLIS layer generally are larger than the corresponding region of a design that will be produced therefrom. This results from the offset created by a cutting tool such as a router. Thus, if a design of a certain size is desired, template regions should be cut fractionally larger than the corresponding region of the design to accommodate the offset of whatever cutting tool is being used.

As shown in FIG. 2C, in another aspect the template regions of at least 2 layers of an MLIS partially overlap. The overlap facilitates greater accuracy in reproducing designs, for example designs with sharp corners and/or angles. While overlaps can be positioned at any place on the design, preferably overlap(s) are at least positioned at a region(s) where there are sharp corners or angles. As FIG. 2C illustrates, the overlap 38 facilitates accurate representation of the sharp corners at the top and bottom of the hole in the center of the letter “D”. Dimensions of the overlap generally will be in a range of 0.1 to 1 inch depending on the size of the layer, inlay shape, and other parameters such as the radius of a cutting bit when using a router.

The layers of a MLIS device of the present invention are applied sequentially to cut inlay portions and their corresponding pockets in a workpiece. While the sequence of application of each layer is not per se fixed by design, a particular order of application may be preferred in order to achieve the most desirable aesthetic effect. In a preferred embodiment, each layer of an MLIS is given an identifying mark 32 to designate an order of application during use. The identifying mark can be placed anywhere on the surface of the base platform, e.g. at a corner, and be any type of identifier, for example, a number, letter, or alphanumeric symbol.

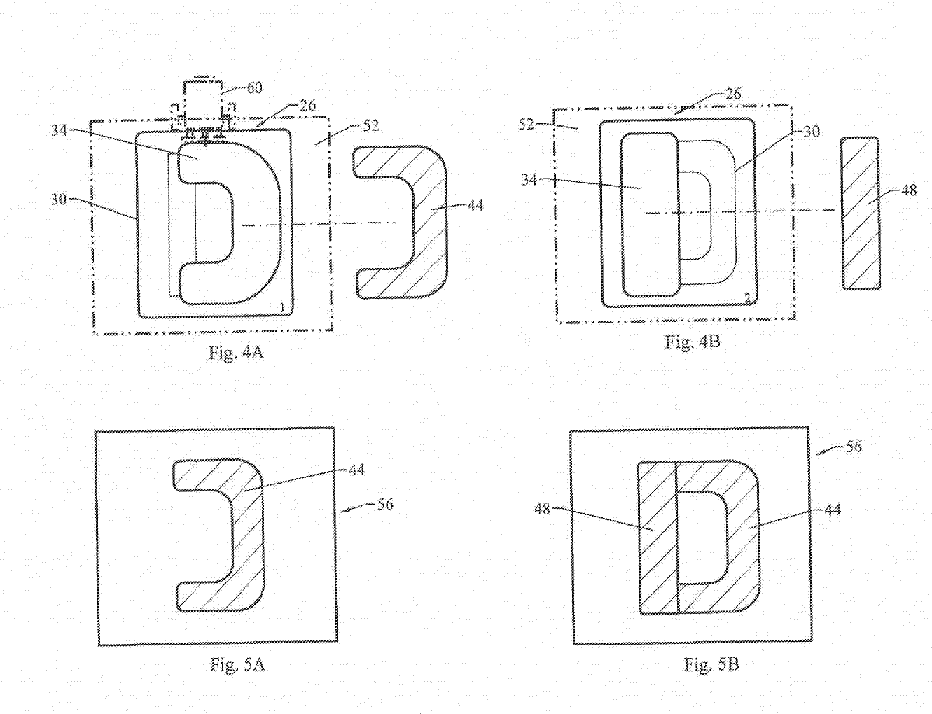

For woodworking applications, the MLIS of the invention is preferably used with a plunge router to cut inlays and corresponding pockets in a base object. FIG. 4A and FIG. 4B illustrate use of a plunge router 60 and two MLIS layers representing the letter “D”. In FIG. 4A, the router 60 is positioned on the inside edge of template region 34 and moved around the perimeter to cut curved inlay piece 44 from inlay material 52. Similarly, vertical section 48 is cut using the second layer depicted in FIG. 4B. FIG. 5A shows curved portion 44 inlaid on the surface of a workpiece 56. FIG. 5B shows workpiece 56 after inlaying vertical section 48. Not depicted is the step of cutting corresponding pockets in the surface of the workpiece to receive the inlay pieces which is performed by applying layer 1 first (shown in FIG. 4A) followed by layer 2 (shown in FIG. 4B) onto the workpiece 56 and cutting the corresponding pockets with a router and collar.

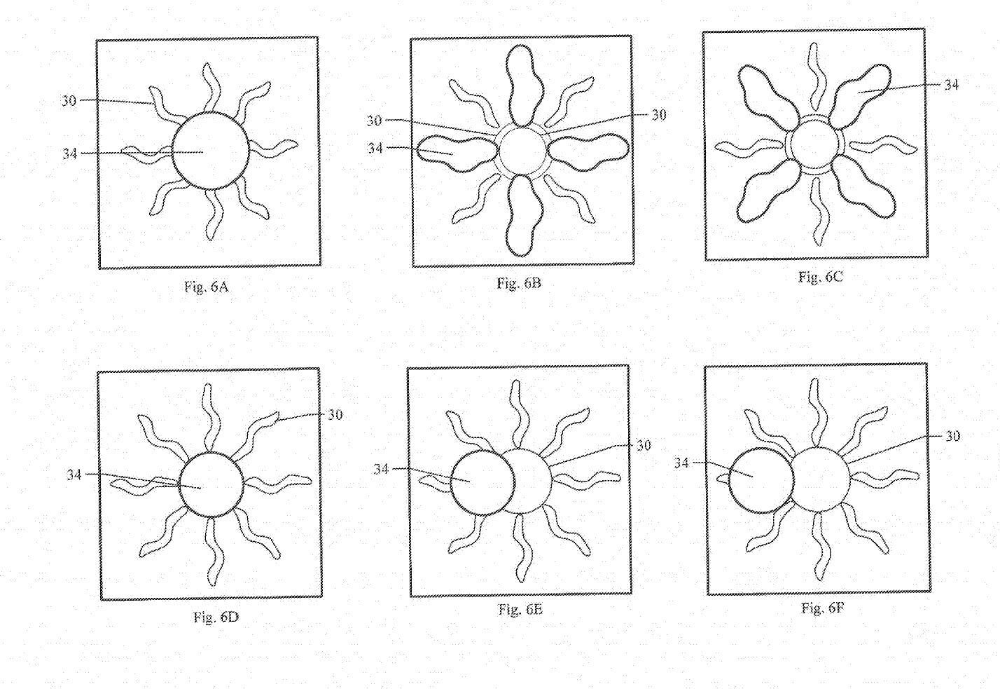

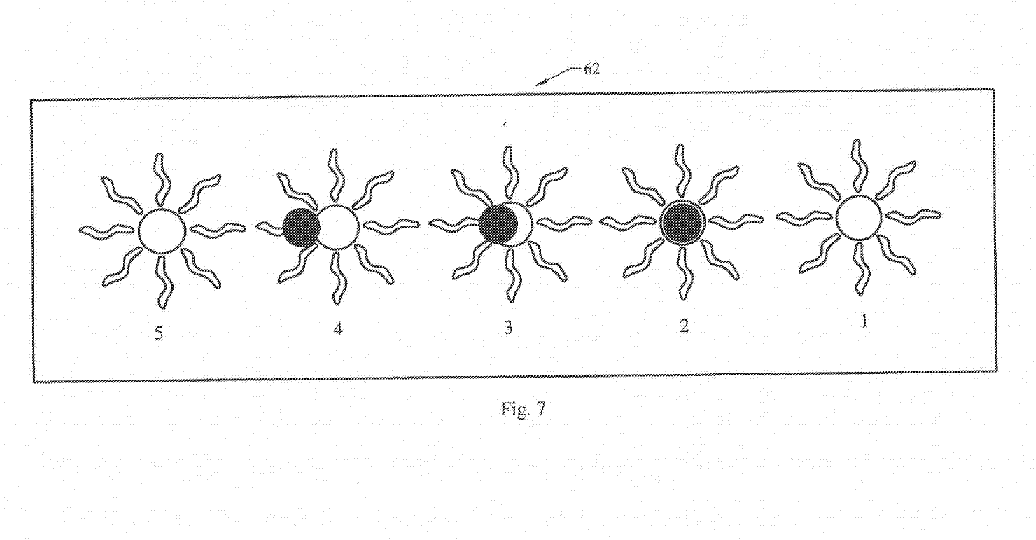

Referring now to FIGS. 6A-6F, shown are 6 layers of an MLIS depicting a solar eclipse. FIG. 7 illustrates a workpiece 62 inlaid with a progressive eclipse produced by the MLIS layers in FIGS. 6A-6F. Image 1 (FIG. 7) is produced by applying layers 1-3 (i.e. layer 1, then layer 2, then layer 3; FIGS. 6A-6C) to cut inlays and corresponding pockets. Image 2 is produced by applying layers 1-4 (FIGS. 6A-6D) and cutting corresponding inlays and pockets. Image 3 is produced by applying layers 1-5 (FIGS. 6A-6E) and cutting corresponding inlays and pockets. Image 4 is produced by applying layers 1-4 and 6 and cutting corresponding inlays and pockets (FIGS. 6A-6D and 6F). Image 5 is produced in the same manner as image 1. The inlay pieces can be cut from different types of wood if desired to enhance contrast and design elegance (e.g. Images 2, 3 and 4).

When working with wood, inlays and corresponding pockets are most conveniently cut with a plunge router. A router generally includes a collar or bushing that rides the internal edge of the template portion of an MLIS layer to recreate the corresponding shape. Router collars are sized to create an offset between the outside of the collar and the cutting edge of the router bit. This offset is important to consider when cutting inlays and corresponding pockets to assure a proper fit of the inlay and pocket. In practice, a router is preferably used without a collar to cut inlay pieces and with a collar to cut the corresponding pockets in the base object.

In another aspect of the invention, a squaring device is used in conjunction with an MLIS to facilitate alignment of the layers during cutting. Any suitable squaring guide can be used for this purpose. For example, a rectangular positioning plate or guide can be provided to achieve proper alignment. Preferably a positioning plate or guide is of the same thickness as an MLIS layer to ensure an even surface for a router to move over, and to prevent fall-off damage by the router to the MLIS layer while cutting inlays or pockets.

Table 1 provides examples of designs and shapes that can be produced by an MLIS of the present invention. These examples are merely illustrative and should not be viewed as limiting the scope of the invention in any way. An MLIS device can be applied to create an inlay of virtually any desired shape or design.

TABLE 1
Example designs produced with an MLIS

| Design | Example |
|---|---|
| Numbers | 0, 1, 2, 3, . . . , ∞ |
| | I, II, III, IV, . . . |
| Letters | A, a, B, b, c, D, . . . , Z, z |
| Symbols | #, $, @, %, &, \|, *, \hat{ }, +, =, ″, ; |
| 2D and 3D Geometric | Rectangle, square, triangle, circle, arc, 5- |
| shapes | point star, diamond, polygon, pentagon, |
| | hexagon, heptagon, octagon, nonagon, |
| | decagon, rod-shape, straight line-shape, |
| | squiggly line, cube, ellipse, parallelogram, |
| | oval, crescent, trapezoid, rhombus |
| Landscape designs | Trees, sunset, ocean, mountains, rivers, lake, |
| | city skyline. |
| Words | Peace, Tarter Woodworking, Addresses, etc. |
| Flags and logos | American flag, country flag, organization |
| | flags, state flags, club flags, organization |
| | logos, club logos |
| Animals, plants | Dog, cat, lion, buck, fish, insect, butterfly, |
| | flowers |

In another aspect, the invention relates to any base object, project, or workpiece having a design or inlay produced by applying a multi-layered stencil according to the present invention. Exemplary, but non-exclusive inlaid articles that can be produced by a method of the invention include design graphics, pottery, crafted art pieces, any type of furniture including but not limited to tables, chairs, cabinets, desks, shelves, and signs, plaques, woodworking crafts, in any suitable material including but not limited to wood, plastic, and metal.

In another aspect, the present invention relates to a kit comprising at least one or more layers of an MLIS of the invention for representing any shape or design. A kit may optionally also include one or more positioning plates and instructions for use. Exemplary but not exclusive kits can include any one or all letters of the English or foreign language alphabet, and any one or all numbers in any number system such as Arabic or Roman numerals, natural numbers, integers, decimals, etc. for example, from 0 to 9.

While the form of the device herein described constitutes a preferred embodiment of the invention, it should be understood that the invention is not limited to the precise from of apparatus or device, and that changes may be made therein without departing from the scope of the invention.

### EXAMPLE 1

### MLIS Kit for Depicting a Mountain Sunset

A kit includes three clear acrylic MLIS plates that measure 4 inches in height, 8 inches in width, and 0.22 inches in thickness. Each layer represents a portion of the mountain sunset design.

### EXAMPLE 2

### Preparation of a Wood Inlay

A suitably-sized piece of Wenge wood is taped or otherwise secured to a work bench. MLIS layers are secured to the inlay wood. A ⅛^{th} inch bit router inlay kit with 0.2 inch bushing depth is installed on a plunge router (Whiteside 9500 inlay kit) without a brass ring or collar, and the cutting depth set to cut through the inlay wood. A first inlay piece corresponding to a first MLIS layer is cut from the wood by placing the router bit inside the template region of the first layer and moving the router around the perimeter to cut out the inlay portion. Succeeding layers of the MLIS are applied sequentially to cut additional portions of the inlay design.

### EXAMPLE 3

### Preparation of Inlay Pockets

A project board is prepared to receive an inlay. The board is secured to a work bench and squared using positioning plates. A first layer of an MLIS is secured to the project board. A plunge router equipped with an inlay kit (Whiteside 9500 inlay kit) and brass collar is set to cut to a depth slightly less than the thickness of an inlay piece. A pocket is created by cutting around the internal edge of the template region of the MLIS and then moving the router back and forth to remove the wood remaining with the template region. After cutting a pocket, a corresponding inlay piece is glued into the pocket and then sanded smooth. Thereafter, additional layers of the MLIS are applied to cut remaining segments of the inlay and corresponding pockets to complete the design. After the final inlay piece is set, the inlaid design is sanded smooth and the project finished as desired.

### EXAMPLE 4

### Preparation of a Solar Eclipse Inlay

A complex inlay for the solar eclipse depicted in FIG. 7 is prepared by applying the six-layer MLIS depicted in FIGS. 6A-6F. Inlay pieces are cut with a plunge router from two different wood types to enhance contrast and aesthetic appeal in the finished inlay. The larger circle, representing the sun and eight emanating rays, are cut from a lighter-colored wood, while the smaller circle depicting the eclipsing moon is cut from a darker-colored wood.

The inlay pieces for image 1 depicting the larger circle and 8 emanating rays of the sun is prepared by applying, in sequence layers 1-3 (FIGS. 6A-6C). Image 2 is produced by applying in sequence layers 1-4; image 3 by applying in sequence 1-5; image 4 by applying in sequence layers 1-4 and 6; and image 5 by applying in sequence layers 1-3.

The layers are applied to the inlay wood, secured with a clamp, tape, or any other suitable means, and a plunge router is used to cut out the corresponding shapes. Pockets corresponding to the inlay pieces are cut in a similar fashion from the base object and the appropriate inlay pieces inserted in the pockets and glued to complete the design.

What is claimed is:

1. A multi-layered stencil device for producing a design comprising:
a plurality of uniformly sized layers adaptable for sequential application to produce the design, comprising:
i. a base platform;
ii. an opening through the base platform said opening serving as a template region to represent a portion of the design;
wherein the template region of one layer partially overlaps with the template region on at least one other layer, and wherein the plurality of template regions represent the complete design.

2. The multi-layered stencil of claim 1 wherein the platform of each layer has an upper planar surface further comprising ghost lines that depict regions of the design that are not represented by the template region of each layer.

3. The multi-layered stencil of claim 2 wherein the base platform is fabricated from plastic.

4. The multi-layered stencil of claim 3 wherein the plastic is transparent acrylic.

5. The multi-layered stencil of claim 4 wherein each layer includes a mark indicating a position in the sequence of application of layers.

6. The multi-layered stencil of claim 5 wherein each layer has a width of 1 to 24 inches, a height of 1 to 24 inches, and a thickness of 0.1 to 0.4 inches.

7. The multi-layered stencil of claim 6 wherein the thickness is 0.22 inches.

8. The multi-layered stencil of claim 7 wherein the design represents a letter, sequence of letters, word, phrase, number, geometric pattern, symbol, artistic image, or landscape.

9. A method for producing an inlay on the surface of an object comprising the steps of:
a. applying a first layer of an MLIS to a material from which a corresponding first portion of the inlay is cut, said first layer having a template region for a portion of the design;
b. cutting a pocket in the object to receive the first inlay portion, said pocket corresponding in shape to the first portion of the inlay;
c. placing the first portion of the inlay into the pocket cut at step b;
d. thereafter applying at least one additional layer of the MLIS to the same or different material to cut one or more additional portions of the inlay, said additional layers providing a template for the additional portion of the inlay; and
e. after each layer of step d is applied, cutting corresponding additional pockets in the object and placing the additional inlay portion cut at step d into the corresponding additional pockets.

10. The method of claim 9 wherein the inlay material is wood.

11. The method of claim 10 wherein the MLIS layers are transparent plastic having a width of 1 to 24 inches, a height of 1 to 24 inches, and a thickness of 0.1 to 0.4 inches.

12. The method of claim 11 wherein the surface of the object is wood and the inlay portions and corresponding pockets are cut with a router.

13. A product having an inlay prepared by the process of:
a. applying a first layer of an MLIS having a template region for a portion of the design to a material from which a corresponding first portion of the inlay is cut;
b. cutting a pocket in the product to receive the first inlay portion, said pocket corresponding in shape to the first portion of the inlay;
c. placing the first portion of the inlay cut at step a into the pocket cut at step b;
d. thereafter applying at least one additional layer of the MLIS to a material that is the same or different from the material of step a, to cut one or more additional portions of said inlay shape, said additional layers providing a template for the additional portions of said inlay shape; and
e. after each layer of step d is applied to cut additional inlay portions, cutting corresponding additional pockets in the product and placing the additional inlay portions into the corresponding additional pockets.

14. The product of claim 13 wherein the MLIS includes from 2 to 10 layers.

15. The product of claim 14 wherein the inlay portions and pockets are cut using a router.

16. The product of claim 15 wherein the product is a piece of furniture, sign, or plaque.

17. The product of claim 16 wherein the inlay design includes an element selected from a number, letter, geometric figure, symbol, word, and flag.

18. A kit comprising an MLIS device of claim 8 for preparing an inlay design on an object.

19. The kit as in claim 18 further comprising one or more positioning plates for aligning the layers during use to cut an inlay or corresponding pocket.
